(19) United States
(12) Patent Application Publication
(10) Pub. No.: US 2024/0412229 A1
(43) Pub. Date: Dec. 12, 2024

(54) SYSTEMS AND METHODS FOR ACCESSING DIGITAL COLLECTIBLES

(71) Applicant: Novajax, Inc., Dublin, OH (US)

(72) Inventors: Amer Ghanem, West Chester, OH (US); Shaminder Rai, Dublin, OH (US); Kenneth Fernandez Prada, San Jose, CA (US)

(21) Appl. No.: 18/731,412

(22) Filed: Jun. 3, 2024

Related U.S. Application Data
(60) Provisional application No. 63/506,058, filed on Jun. 3, 2023.

(51) Int. Cl. G06Q 30/018; G06Q 20/36

(52) U.S. Cl. CPC G06Q 30/018; G06Q 20/367

(57) ABSTRACT

Disclosed herein are methods and systems for automated retrieval of digital collectibles based on scanning identifiers embedded within physical merchandise items.

### CROSS-REFERENCE TO RELATED APPLICATIONS

This application claims priority to U.S. Provisional Patent Application No. 63,506,058 filed on Jun. 3, 2023, and titled, “SYSTEMS AND METHODS FOR ACCESSING DIGITAL COLLECTIBLES”. The entirety of the aforementioned application is incorporated by reference herein.

### BACKGROUND

Conventional processes of accessing digital collectibles involve inefficient mechanisms by which a user experience is eroded. For instance, a user may access a marketplace and knowing the digital collectible desired, purchase the digital collectible via a website. However, the user does not engage with the brand during such process or participate in a unique experience during the purchase process. As such, there is a need for convenient and engaging mechanisms for access to digital collectibles.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods configured to automatically retrieve digital collectibles.

According to an embodiment, a method of automatically retrieving a digital collectible is provided. The method can comprise a client device scanning a communication chip embedded within a merchandise item. Furthermore, the method can include an application executing on the client device automatically rendering a profile access interface. In another aspect, the method can include an authentication module of the application executing on the client device granting access to a profile corresponding to the communication chip embedded within the merchandise item based on an authentication of a requestor. Also, the method can include a claiming module of the application executing on the client device selecting a digital collectible comprising a unique identifier associated with the communication chip embedded within the merchandise item.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 illustrates an overview of a representative environment in which the automated digital device management operations can be executed in accordance with one or more implementations.

FIG. 2 illustrates an example, non-limiting method of automatically retrieving a digital collectible in accordance with one or more implementations.

FIG. 3 illustrates an example, non-limiting method of automatically retrieving a digital collectible in accordance with one or more implementations.

FIG. 4 illustrates a block diagram representing an exemplary non-limiting operating environment in which the various embodiments may be facilitated.

FIG. 5 illustrates a block diagram representing an exemplary non-limiting computing environment in which the various embodiments may be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

By way of a non-limiting introduction, disclosed herein are various non-limiting embodiments of systems and methods for automated management and retrieval of digital collectibles corresponding to various physical products, such as physical merchandise items embedded with communication chip technologies. In an aspect, such retrieval and management systems and methods can be implemented via technical system architectures that create efficiencies for generation and claiming of digital collectibles such as non-fungible tokens (NFT's) identifying particular merchandise items. In an aspect, the digital collectible (e.g., NFT) can comprise a string of cryptographic hashes representing a digital signature that can provide a unique identity and ownership of an underlying merchandise item (e.g., identifiable via a unique NFC tag). Furthermore, the digital collectible can include metadata or other attributes associated with the identity of the merchandise item or user scanning an NFC tag.

In a non-limiting example, a merchandise item such as a shirt can be embedded with a communication device such as a near-field communication (NFC) chip configured (e.g., via an NFC tag) to be recognized by a scanner of a client device (e.g., a smartphone, tablet, etc.). The NFC chip can serve as a linking mechanism between the physical shirt and the digital collectible. Furthermore, the NFC chip can act as an access control mechanism (e.g., each time the NFC chip is recognized or scanned) configured to grant access to experiences corresponding to a specific digital collectible. Accordingly, the scanned NFC tag can be recognized by an application executing on the client device and generate an authentication interface. Upon authentication of an authorized requestor, a digital collectible associated with the merchandise item can be selected and stored at a user wallet.

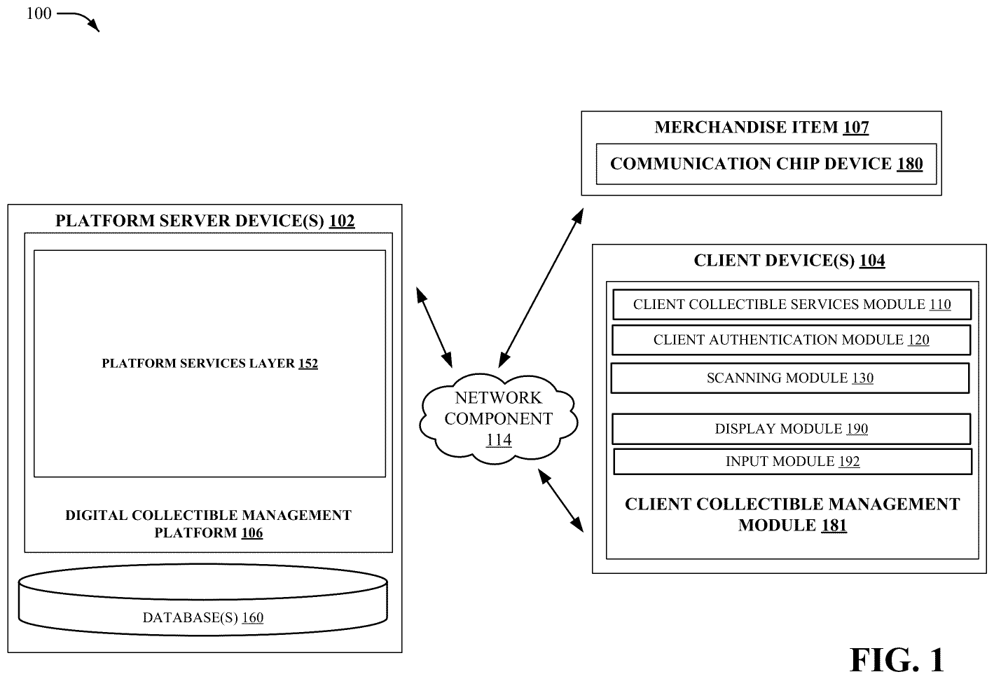

Referring now to FIG. 1, illustrated is a non-limiting example environment 100 that can be used to automatically retrieve a digital collectible. In an aspect, environment 100 can include one or more server device(s) 102 and one or more computing device(s) 104. Computing device(s) 104 can be any suitable computing device (e.g., desktop computer, mobile phone, tablet, laptop, smart watch, etc.). In an aspect, one or more server device(s) 102 can employ digital collectible management platform 106 that can employ platform services layer 152 configured to facilitate all interactions between computing device(s) 104 and platform server device(s) 102. For instance, digital collectible management platform 106 can enable the tracking, analyzing, (e.g., interactions with the digital experience, fan engagement, likelihood to purchase experiences or products, feasibility of fan group creation, etc.), validation, and/or verification of devices or requestors requesting access to a digital asset associated with a particular merchandise item.

In an aspect, digital collectible management platform 106 can comprise one or more various components and/or modules that can be communicatively coupled to a workload layer of a cloud computing environment to distribute processing activities (e.g., processing authentication operations, digital collectible claiming activities, smart contract management activities, deployment of experiences, etc.) across a cloud environment. In one or more non-limiting embodiments, environment 100 may be configured for use with one or more blockchain network (e.g., Ethereum blockchain network) configured to implement target token standards. For instance, the blockchain may include a trusted ledger framework maintained by a distributed peer-to-peer network.

In an aspect, digital collectible management platform 106 can comprise various components, modules, and frameworks implemented to support, create, and manage the automated retrieval of digital collectibles. In one or more non-limiting implementations, the interconnected architecture of server device(s) 102 allows digital collectible management platform 106 to scale and/or manage resources to optimally tailor experiences to all client devices (e.g., computing device(s) 104) receiving services. In an aspect, application services layer 152, can be configured to implement functionality associated with retrieval and management of digital collectibles. Furthermore, the digital collectible management platform 106 can employ an interface configured to permit client device 104 access to a series of applications in a uniform manner.

For instance, digital collectible management platform 106 can enable applications to communicate within a common layer with a common application interface while also maintaining compartmentalization of application components. Furthermore, in an aspect, application level operations can be aggregated and used by several client devices. In another aspect server device(s) 102 can also include In another non-limiting embodiment, digital collectible management platform 106 can also provide technical capabilities that support application services layers.

In yet another non-limiting embodiment, digital collectible management platform 106 can mediate operations between a database 160 and application services layers. In another aspect, digital collectible management platform 106 can employ gateway and integration layers configured to register a requestor through an application programming interface (API). In an aspect, database 160 can be configured to store information such as data, organize large volumes of data and address large amounts of structured and unstructured data. In an aspect, database(s) 160 can include one or more database interfaces such as SQL interfaces. Furthermore, database(s) 160 can be configured to receive database access commands, consolidate data access events. In another aspect, digital collectible management platform 106 can employ an artificial intelligence module configured to analyze a user utilization of a digital asset (e.g., NFT) to generate data driven insights for a target audience (e.g., brands, fans, etc.).

In another aspect, server(s) 102 can communicate with client device(s) 104 via protocol stacks associated with a network 114 over which data can be exchanged, firmware that can cause the hardware to generate signals and/or process messages used to maintain a wireless communication session. In yet another aspect, client device(s) 104 can employ client collectible management module 181 configured to execute client collectible services module 110, client authentication module 120, scanning module 130, display module 190, and input module 192. In an aspect, client collectible management module 181 can communicate with platform services layer 152. Furthermore, client collectible services module 110 can be configured to allow interactions with a digital collectible (e.g., claim the digital collectible). In another aspect, client authentication module 120 can be configured to initiate authentication activities by platform 152. For instance, platform 152 can grant access to a profile corresponding to the NFC chip embedded within the merchandise item based on an authentication initiated by a requestor via authentication module 120. In another aspect, scanning module 130 can be utilized to scan a communication chip embedded within a merchandise item.

In yet another aspect, display module 190 can be configured to render to a user access to features supported by the digital collectible management platform 106. In another aspect, input module 192 can be configured to receive an input query for application to platform services layer 152. Environment 100 can also include merchandise item 107 which can be a physical item or physical product that embeds the communication chip device 180 (e.g., NFC chip, RFID technologies, long range radio technologies, ultrawide band technologies or other readable device technologies) within its body.

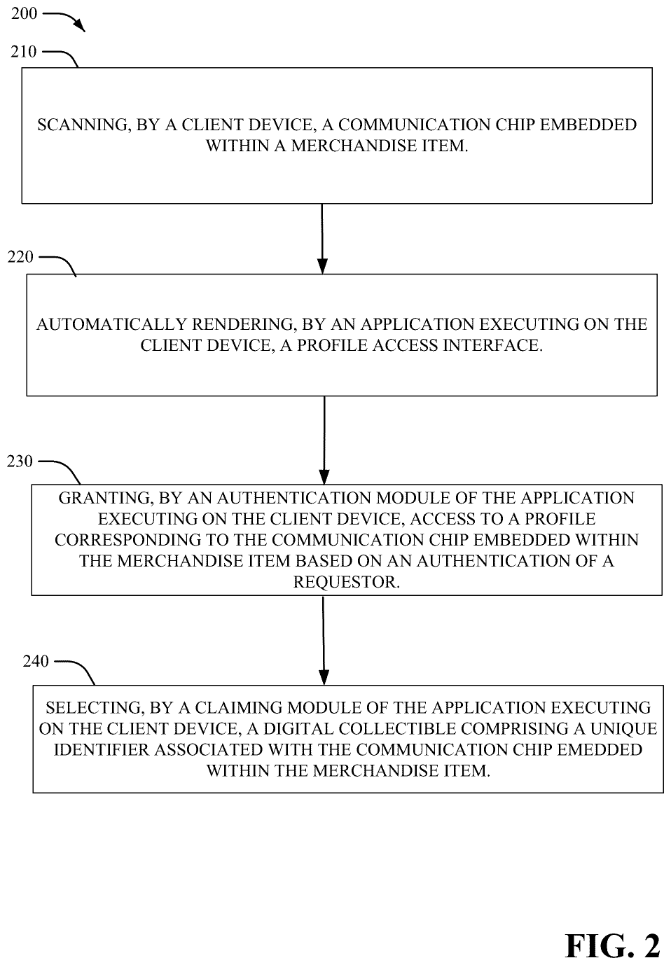

Turning now to FIG. 2, illustrated is an example, non-limiting method 200 of automatically retrieving a digital collectible in accordance with one or more implementations. Repetitive description of like elements employed in other embodiments described herein are omitted for sake of brevity.

The method can be performed by a suitable combination of hardware, software, and/or firmware. In at least some embodiments, aspects of the method can be implemented by one or more suitably configured hardware components and/or software modules, such as those associated with server(s) 102 and or client device(s) 104 in environment 100. While the method described in FIG. 2 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

At reference numeral 210, a client device (e.g., client device 104) can scan a communication chip (e.g., communication chip device 180) embedded within a merchandise item (e.g., merchandise item 107). At reference numeral 220, an application executable by the client device can automatically render (e.g., using display module 190) a profile access interface. At reference numeral 230, an authentication module (e.g., client authentication module 120) grants (e.g., using digital collectible management platform 106) the client device access to a profile corresponding to the communication chip embedded within the merchandise item based on an authentication of a requestor. At reference numeral 240, a claiming module selects (e.g., using digital collectible management platform 106) a digital collectible comprising a unique identifier associated with the communication chip embedded within the merchandise item.

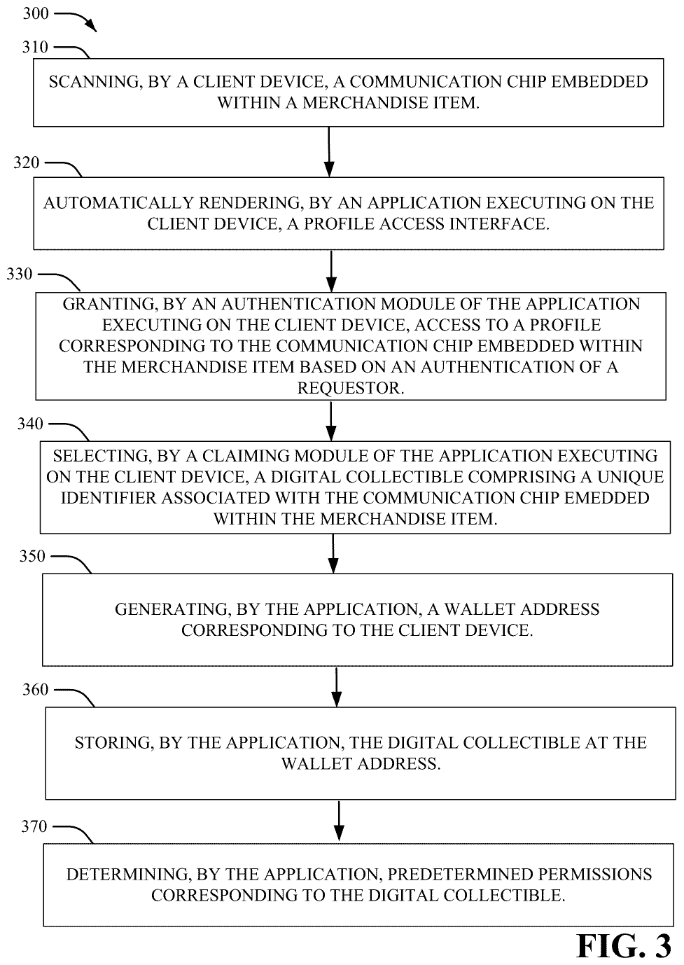

Turning now to FIG. 3, illustrated is an example, non-limiting method 300 of automatically retrieving a digital collectible in accordance with one or more implementations. Repetitive description of like elements employed in other embodiments described herein are omitted for sake of brevity.

The method can be performed by a suitable combination of hardware, software, and/or firmware. In at least some embodiments, aspects of the method can be implemented by one or more suitably configured hardware components and/or software modules, such as those associated with server(s) 102 and or client device(s) 104 in environment 100. While the method described in FIG. 3 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

At reference numeral 310, a client device (e.g., client device 104) can scan a communication chip (e.g., communication chip device 180) embedded within a merchandise item (e.g., merchandise item 107). At reference numeral 320, an application executable by the client device can automatically render (e.g., using display module 190) a profile access interface. At reference numeral 330, an authentication module (e.g., client authentication module 120) grants (e.g., using digital collectible management platform 106) the client device access to a profile corresponding to the communication chip embedded within the merchandise item based on an authentication of a requestor. At reference numeral 340, a claiming module selects (e.g., using digital collectible management platform 106) a digital collectible comprising a unique identifier associated with the communication chip embedded within the merchandise item. At reference numeral 350, the application generates a wallet address corresponding to the client device. At reference numeral 360, the application stores the digital collectible at the wallet address. At reference numeral 370, the application determines predetermined permissions corresponding to the digital collectible.

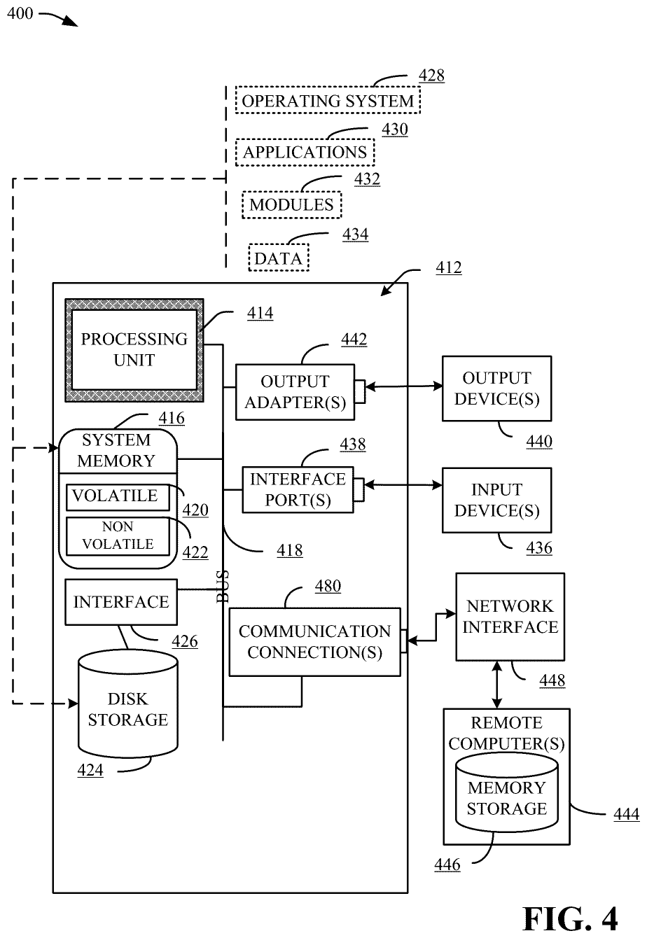

FIG. 4 illustrates a block diagram representing an exemplary non-limiting operating environment in which the various embodiments may be facilitated. Repetitive description of like elements employed in other embodiments described herein are omitted for sake of brevity.

In order to provide a context for the various aspects of the disclosed subject matter, FIG. 4 as well as the following discussion is intended to provide a general description of a suitable environment in which the various aspects of the disclosed subject matter can be implemented. FIG. 4 illustrates a block diagram of an example, non-limiting operating environment in which one or more embodiments described herein can be facilitated. With reference to FIG. 4, a suitable operating environment 400 for implementing various aspects of this disclosure can also include a computer 412. The computer 412 can also include a processing unit 414, a system memory 416, and a system bus 418. The system bus 418 couples system components including, but not limited to, the system memory 416 to the processing unit 414. The processing unit 414 can be any of various available processors. Dual microprocessors and other multiprocessor architectures also can be employed as the processing unit 414. The system bus 418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 416 can also include volatile memory 420 and nonvolatile memory 422. The basic input/output system (BIOS), containing the basic routines to transfer information between elements within the computer 412, such as during start-up, is stored in nonvolatile memory 422. By way of illustration, and not limitation, nonvolatile memory 422 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 420 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 412 can also include removable/non-removable, volatile/non-volatile computer storage media. FIG. 4 illustrates, for example, a disk storage 424. Disk storage 424 can also include, but is not limited to, devices like a magnetic disk drive, floppy disk drive, tape drive, Jaz drive, Zip drive, LS-100 drive, flash memory card, or memory stick. The disk storage 424 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 424 to the system bus 418, a removable or non-removable interface is typically used, such as interface 426. FIG. 4 also depicts software that acts as an intermediary between users and the basic computer resources described in the suitable operating environment 400. Such software can also include, for example, an operating system 428. Operating system 428, which can be stored on disk storage 424, acts to control and allocate resources of the computer 412.

System applications 430 take advantage of the management of resources by operating system 428 through program modules 432 and program data 434, e.g., stored either in system memory 416 or on disk storage 424. It is to be appreciated that this disclosure can be implemented with various operating systems or combinations of operating systems. A user enters commands or information into the computer 412 through input device(s) 436. Input devices 436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 414 through the system bus 418 via interface port(s) 438. Interface port(s) 438 include, for example, a serial port, a parallel port, a game port, and a universal serial bus (USB). Output device(s) 440 use some of the same type of ports as input device(s) 436. Thus, for example, a USB port can be used to provide input to computer 412, and to output information from computer 412 to an output device 440. Output adapter 1242 is provided to illustrate that there are some output device 440 like monitors, speakers, and printers, among other such output device 440, which require special adapters. The output adapters 442 include, by way of illustration and not limitation, video and sound cards that provide a means of connection between the output device 440 and the system bus 418. It should be noted that other devices and/or systems of devices provide both input and output capabilities such as remote computer(s) 444.

Computer 412 can operate in a networked environment using logical connections to one or more remote computers, such as remote computer(s) 444. The remote computer(s) 444 can be a computer, a server, a router, a network PC, a workstation, a microprocessor based appliance, a peer device or other common network node and the like, and typically can also include many or all of the elements described relative to computer 412. For purposes of brevity, only a memory storage device 446 is illustrated with remote computer(s) 444. Remote computer(s) 444 is logically connected to computer 412 through a network interface 448 and then physically connected via communication connection 450. Network interface 448 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 450 refers to the hardware/software employed to connect the network interface 448 to the system bus 418. While communication connection 450 is shown for illustrative clarity inside computer 412, it can also be external to computer 412. The hardware/software for connection to the network interface 448 can also include, for exemplary purposes only, internal and external technologies such as, modems including regular telephone grade modems, cable modems and DSL modems, ISDN adapters, and Ethernet cards.

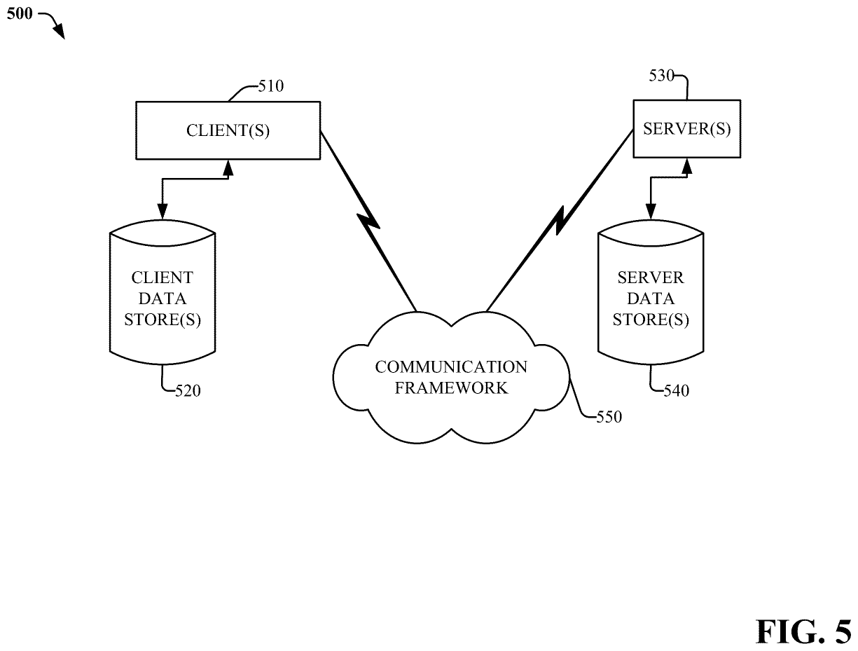

FIG. 5 illustrates a block diagram representing an exemplary non-limiting computing environment in which the various embodiments may be facilitated.

The system 500 includes one or more client(s) 502 (e.g., laptops, smart phones, PDAs, media players, computers, portable electronic devices, tablets, and the like). The client(s) 502 can be hardware and/or software (e.g., threads, processes, computing devices). The system 500 also includes one or more server(s) 504. The server(s) 504 can also be hardware or hardware in combination with software (e.g., threads, processes, computing devices). The servers 504 can house threads to perform transformations by employing aspects of this disclosure, for example. One possible communication between a client 502 and a server 504 can be in the form of a data packet transmitted between two or more computer processes wherein the data packet may include video data. The data packet can include a metadata, e.g., associated contextual information, for example. The system 500 includes a communication framework 506 (e.g., a global communication network such as the Internet, or mobile network(s)) that can be employed to facilitate communications between the client(s) 502 and the server(s) 504.

Communications can be facilitated via a wired (including optical fiber) and/or wireless technology. The client(s) 502 include or are operatively connected to one or more client data store(s) 508 that can be employed to store information local to the client(s) 502 (e.g., associated contextual information). Similarly, the server(s) 504 are operatively include or are operatively connected to one or more server data store(s) 510 that can be employed to store information local to the servers 504. In one embodiment, a client 502 can transfer an encoded file, in accordance with the disclosed subject matter, to server 504. Server 504 can store the file, decode the file, or transmit the file to another client 502. It is to be appreciated, that a client 502 can also transfer uncompressed file to a server 504 and server 504 can compress the file in accordance with the disclosed subject matter. Likewise, server 504 can encode video information and transmit the information via communication framework 506 to one or more clients 502.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, Python, C, Solidity, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of automatically retrieving a digital collectible comprising:
scanning, by a client device, a communication chip embedded within a merchandise item;
automatically rendering, by an application executing on the client device, a profile access interface;
granting, by an authentication module of the application executing on the client device, access to a profile corresponding to the communication chip embedded within the merchandise item based on an authentication of a requestor; and
selecting, by a claiming module of the application executing on the client device, a digital collectible comprising a unique identifier associated with the communication chip embedded within the merchandise item.

2. The method of claim 1, further comprising:
generating, by the application, a wallet address corresponding to the client device;
storing, by the application, the digital collectible at the wallet address; and
determining, by the application, predetermined permissions corresponding to the digital collectible.

3. The method of claim 3, further comprising:
scanning, by the client device, the communication chip;
granting, by the authentication module of the application, access to permitted content based on a comparison of the profile identifier to a set of authentication information.

4. The method of claim 3, further comprising:
executing, by the application, a media item based on access to the permitted content.
